(19) United States
(12) Patent Application Publication
(10) Pub. No.: US 2025/0139563 A1
(43) Pub. Date: May 1, 2025

(54) OPERATOR FEEDBACK AND TRAINING FOR REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Elmira, NY (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/923,922

(22) Filed: Oct. 23, 2024

Related U.S. Application Data
(60) Provisional application No. 63/593,788, filed on Oct. 27, 2023.

(51) Int. Cl. G06Q 10/0639; G07C 5/08

(52) U.S. Cl. CPC G06Q 10/06398; G07C 5/0808; G07C 5/0825

(57) ABSTRACT

A system for monitoring an operation of a refuse vehicle includes a device configured to collect data pertaining to operations of the refuse vehicle and a performance of an operator, and one or more processing circuits in communication with the device. The one or more processing circuits are configured to receive, from the device, the data pertaining to operations of the refuse vehicle and the performance of the operator, analyze the data based on baseline data, the baseline data pertaining to a baseline value of the operations of the refuse vehicle and the performance of the operator, generate, based on an analysis of the data, an operator score, and provide, via a display, a user interface that includes the operator score.

### CROSS-REFERENCE TO RELATED PATENT APPLICATIONS

This application claims the benefit of and priority to U.S. Provisional Application No. 63/593,788, filed on Oct. 27, 2023, the entire disclosure of which is hereby incorporated by reference herein.

### BACKGROUND

The present disclosure generally relates to the field of refuse vehicles. More specifically, the present disclosure relates to control systems for refuse vehicles.

### SUMMARY

One embodiment of the present disclosure relates to a system for monitoring an operation of a refuse vehicle. The system includes a device configured to collect data pertaining to operations of the refuse vehicle and a performance of an operator, and one or more processing circuits in communication with the device. The one or more processing circuits are configured to receive, from the device, the data pertaining to operations of the refuse vehicle and the performance of the operator, analyze the data based on baseline data, the baseline data pertaining to a baseline value of the operations of the refuse vehicle and the performance of the operator, generate, based on an analysis of the data, an operator score, and provide, via a display, a user interface that includes the operator score.

Another embodiment of the present disclosure relates to an operator feedback system for a refuse vehicle. The operator feedback system includes one or more processing circuits comprising one or more memory devices coupled to one or more processors, the one or more memory devices configured to store instructions thereon that, when executed by the one or more processors, cause the one or more processors to receive, from one or more sensors, data associated with a performance parameter regarding an operation of the refuse vehicle and a performance of an operator, analyze the data based on baseline data, the baseline data including a baseline value of the performance parameter, generate, based on an analysis of the data, an operator score indicative of the operation of the refuse vehicle and the performance of the operator, provide, via a display, a user interface that includes the operator score, and provide, via the display, feedback to the operator regarding the operation of the refuse vehicle and the performance of the operator to improve the operator score. The performance parameter includes at least one of an alertness parameter, a component operation parameter, a driving condition parameter, a time parameter, a payload parameter, a route parameter, or a refuse vehicle performance parameter.

Still another embodiment of the present disclosure relates to a method for monitoring an operation of a refuse vehicle. The method includes receiving, from one or more sensors, data associated with a first performance parameter and a second performance parameter regarding an operation of the refuse vehicle and a performance of an operator, aggregating the data received from the one or more sensors, normalizing the data associated the first performance parameter and the second performance parameter to have a common type, generating, based on the normalized data, an operator score indicative of the operation of the refuse vehicle and the performance of the operator, providing, via a display, a user interface that includes the operator score, and providing, via the display, feedback to the operator regarding the operation of the refuse vehicle and the performance of the operator to improve the operator score.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a block diagram of a vehicle monitoring system, according to an exemplary embodiment;

FIG. 7 is a block diagram of the vehicle monitoring system of FIG. 6, according to an exemplary embodiment;

FIG. 8 is a user interface displaying a map, according to an exemplary embodiment;

FIG. 9 is a user interface displaying vehicle information, according to an exemplary embodiment;

FIG. 10 is a user interface displaying vehicle information, according to an exemplary embodiment;

FIG. 11 is a user interface displaying vehicle information, according to an exemplary embodiment;

FIG. 12 is a user interface displaying an operator report including an operator score, according to an exemplary embodiment;

FIG. 13 is a user interface displaying an operator report including operator scores, according to an exemplary embodiment;

FIG. 14 is a block diagram of a tag including a quick-response (QR) code, according to an exemplary embodiment;

FIG. 15 is a block diagram of a tag including a quick-response (QR) code, according to another exemplary embodiment;

FIG. 16 is a block diagram of a tag including a quick-response (QR) code, according to another exemplary embodiment; and

FIG. 17 is a block diagram of an operator score calculation and operator report generation process, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, systems and methods for calculating an operator score and generating an operator report are shown, according to various embodiments. A vehicle detection system is configured to receive data from one or more sensors or devices coupled to various components of the refuse vehicle. Generally, the vehicle detection system is configured to gather data relating to a performance of the vehicle. The vehicle detection system includes one or more sensors or devices configured to capture data corresponding to a parameter related to the performance of the vehicle and/or a performance of an operator. In some embodiments, the parameters include an alertness, a driving condition, a time-related, a payload, a vehicle performance, and/or a start/end of route parameter. The vehicle detection system may transmit the data corresponding to various parameters to a system module configured to aggregate all of the gathered data and perform an analysis on the gathered data. Based on the analysis, the system module may calculate an operator score. The system module may implement one or more models to aggregate and calculate the operator score. Generally, the operator score is indicative of a performance (e.g., efficiency, safety, etc.) of the operator. The system module may be further configured to generate an operator report. The system module may provide the operator score and/or the operator report to be displayed on a user interface. A user (e.g., an employer) may navigate, filter, or otherwise review the operator report or the gathered data to assess and compare the performance of one or more operators of the vehicle. The operator report may include an indication that the operator needs training with respect to one or more particular parameters.

### Refuse Vehicle

### Front-Loading Configuration

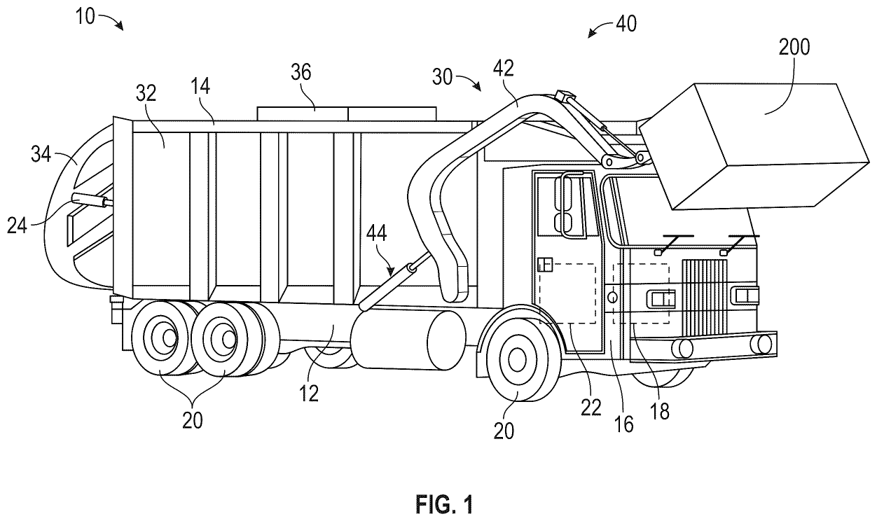

Referring to FIG. 1, a vehicle, shown as refuse vehicle 10 (e.g., a garbage truck, a waste collection truck, a sanitation truck, etc.), is shown that is configured to collect and store refuse along a collection route. In other embodiments, the refuse vehicle 10 is another type of vehicle such as a response vehicle, a police vehicle, an ambulance, a Department of Transportation vehicle, a roadside assistance vehicle, a fire truck, a plow truck, a construction vehicle, a street sweeper, and/or still another type of vehicle. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as tractive elements 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

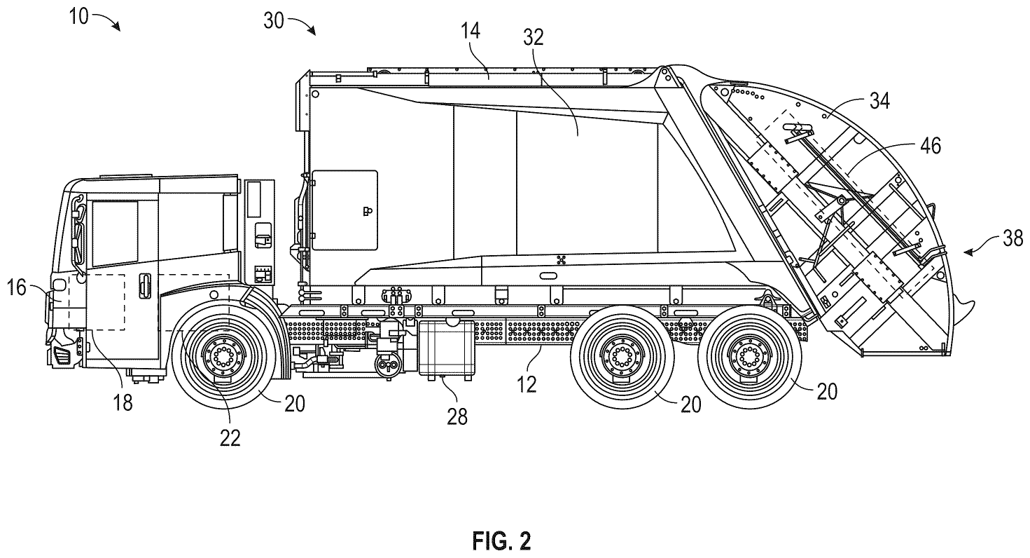

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

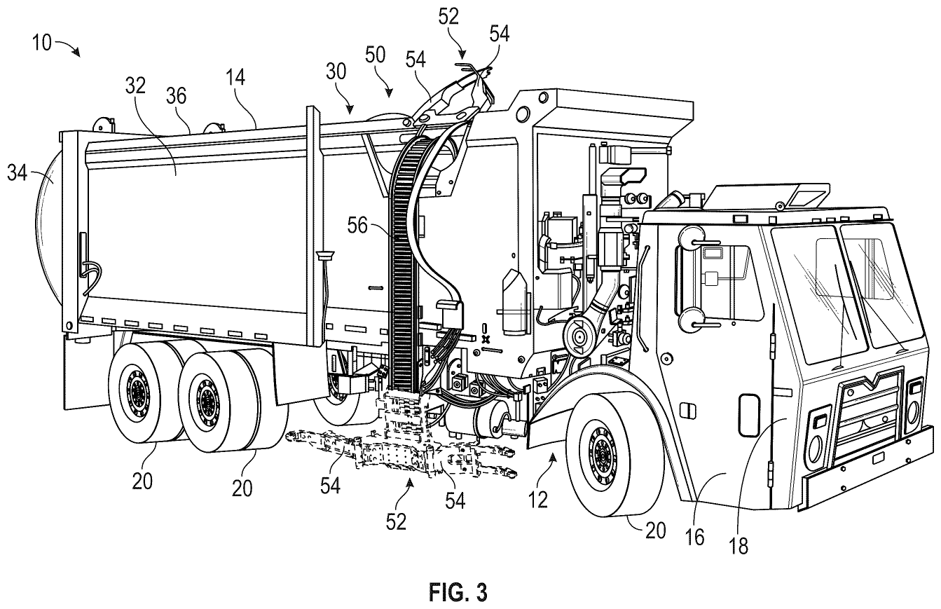

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with the body 14 or frame 12 of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly 52 may transition into the disengaged state, releasing the refuse container.

### Control System

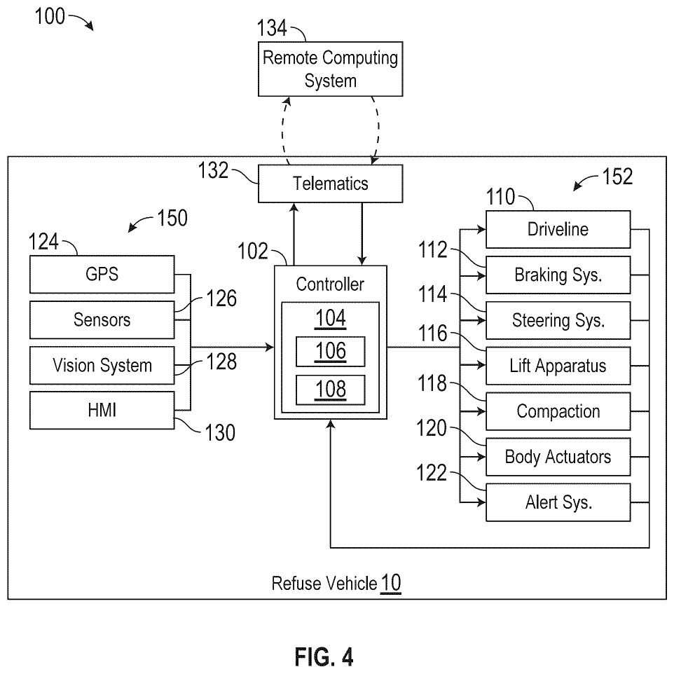

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (GPS) 124, multiple sensors 126, a vision system 128 (e.g., an awareness system), and a Human Machine Interface (HMI) 130. The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller 102 may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

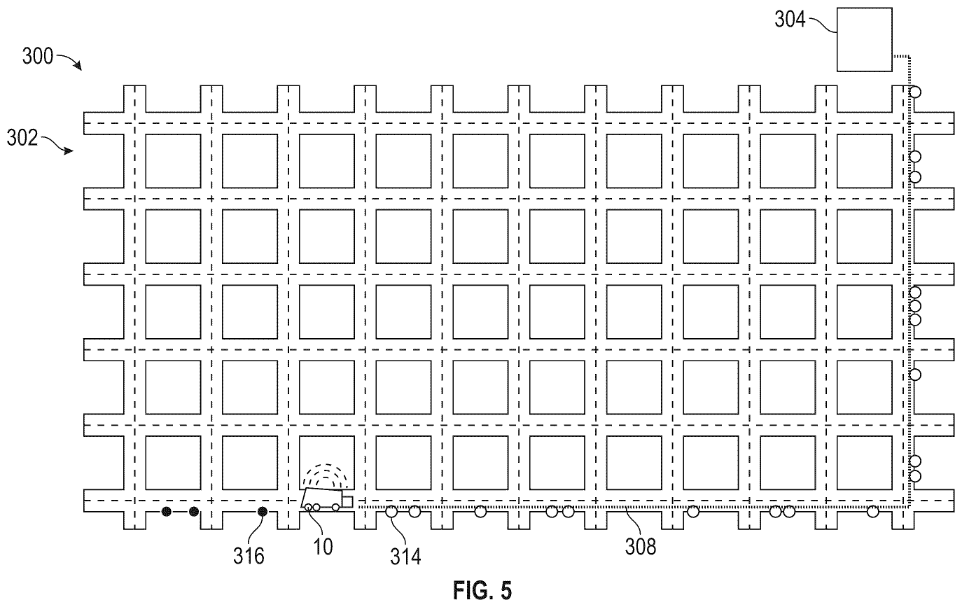

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location, a transfer station, etc.) where the refuse vehicle 10 may autonomously empty collected refuse, transport to a refueling location if necessary, and begin a new route.

### Data Collection System

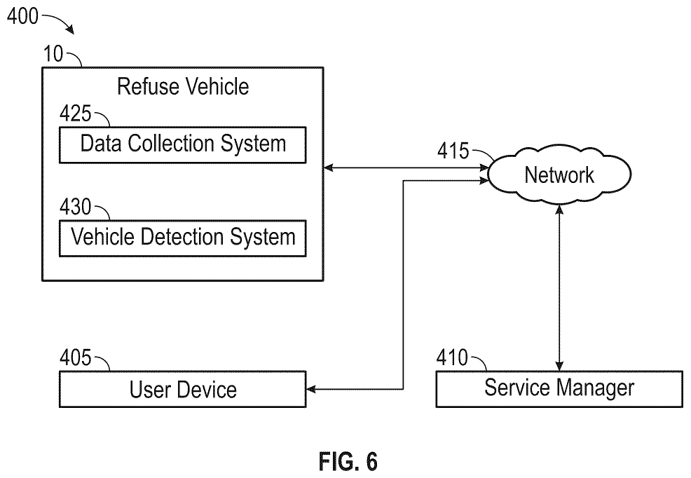

Referring to FIG. 6, a vehicle monitoring system (e.g., an operator scoring system, a feedback system, a training system, etc.) is shown as system 400, according to an exemplary embodiment. The system 400 is configured to receive data from one or more sensors (e.g., sensors 126), components or sub-components (e.g., the engine 18, the tailgate actuators 24, the lift arm actuators 44, the grabber arms 54, etc.), assemblies (e.g., the lift assembly 40, the lift assembly 50, the grabber assembly 52, etc.), and/or systems (e.g., the control system 100, the braking system 112, the steering system 114, the compaction system 118, the alert system 122, the GPS system 124, the vision system 128, the remote computing system 134, etc.) of the refuse vehicle 10.

The system 400 is configured to analyze the received data to generate a score (e.g., a performance indicator, safety score, efficiency grade, etc.) of an operator (e.g., a driver) of the refuse vehicle 10. Generally, the score may be related to a performance of the operator while operating the refuse vehicle 10. By way of example, the score may indicate how efficient the operator is at driving the refuse vehicle 10, how safely the operator operates components of the refuse vehicle 10, and/or a risk factor associated with a particular operator. In some embodiments, the refuse vehicle 10 is operated (e.g., driven, controlled, etc.) by two or more operators working as a crew. In such embodiments, the score may represent a cumulative score of the entire crew.

Referring to FIG. 6, the system includes one or more refuse vehicles 10, one or more user devices (e.g., smartphones, tablets, laptop computers, desktop computers, pagers, smart speakers, AI assistants, etc.), shown as user devices 405, and a service manager (e.g., a cloud device, a cloud server, a cloud controller, etc.), shown as service manager 410.

The components of the system 400 (e.g., the refuse vehicle 10, the user device 405, and/or the service manager 410) may communicate with one another directly and/or across a network 415 (e.g., intranet, Internet, VPN, a cellular network, a satellite network, etc.). In some embodiments, the components of the system 400 communicate wirelessly. By way of example, the system 400 may utilize a cellular network, Bluetooth, near field communication (NFC), infrared communication, radio, or other types of wireless communication. In other embodiments, the system 400 utilizes wired communication.

The vehicle 10 may interface with the user device 405 and/or the service manager 410 (e.g., directly or across the network 415). The vehicle 10 may provide information to the user device 405 and/or the service manager 410 (e.g., via the telematics unit 132). Similarly, the vehicle 10 may receive information from the user device 405 and/or the service manager 410. The information may include information associated with sensor data gathered from the sensors 126, image/video data gathered from the vision system 128, braking data gathered from the braking system 112, steering data gathered from the steering system 114, lift data gathered from the lift apparatus 116, compaction data gathered from the compaction system 118, alerts gathered from the alert system 122, location data (e.g., GPS coordinates) gathered from the GPS system 124, and/or component data gathered from components of the refuse vehicle 10 relating to vehicle operations (e.g., emptying the refuse compartment 30 during an ejection procedure, actuating the lift arms 42, number of vehicle backups, vehicle speed, refuse collection procedures, other vehicle or vehicle body operations, etc.). By way of example, the vehicle 10 may provide a report to the service manager 410 that compiles the information gathered from the various systems and components of the refuse vehicle 10.

As shown in FIG. 6, the refuse vehicle 10 includes a data collection system 425 and a vehicle detection system 430. In some embodiments, the data collection system 425 receives vehicle data (e.g., information as described above) from the vehicle detection system 430, the user device 405, and/or the service manager 410. In some embodiments, the data received includes telematics data. In some embodiments, the data collection system 425, the service manager 410, and the user device 405 interface with one another (e.g., communicate) using a controller area network (CAN). The data collection system 425 may use the vehicle data to determine a score for the operator of the refuse vehicle 10. By way of example, the data collection system 425 may compile data from the vehicle detection system 430 into a report that generates (e.g., calculates) an operator score relating to the performance of the driver.

As described herein, the vehicle detection system 430 may include any type of sensor or device that is configured to capture data associated with the performance (e.g., operation, efficiency, etc.) of the refuse vehicle 10 and the behavior (e.g., performance, efficiency, attentiveness, etc.) of the operator of the refuse vehicle 10. By way of example, the vehicle detection system 430 may be or include one or more sensors 126, devices included in the vision system 128, or any other device positioned about any type of equipment including, but not limited to, the refuse vehicle 10, components of the refuse vehicle 10, machines, tools, refuse cans, etc. to capture vehicle data or operator performance data. The data may include a signal (e.g., raw sensor data, varying voltage levels, varying current levels, digital signal, etc.) that may be associated with or include an indication of the performance of the refuse vehicle 10 and/or the operator.

According to an exemplary embodiment, the vehicle detection system 430 may include any type of device that is configured to capture data associated with the detection of objects such as refuse cans, human beings, phones, hazards, or any other object. In this regard, the vehicle detection system 430 may include any type of image and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by vehicle detection system 430 may include, for example, raw image data from one or more cameras (e.g., visible light cameras) of the vision system 128 and/or data from one or more sensors 126 (e.g., LIDAR, radar, etc.) that may be used to detect objects.

The components of the vehicle detection system 430 (e.g., sensors 126) may be disposed at any number of locations throughout and/or around refuse vehicle 10 for capturing image and/or object data from any direction with respect to refuse vehicle 10. By way of example, the vehicle detection system 430 may include a plurality of visible light cameras and LIDAR cameras/sensors mounted on the forward and lateral sides of the refuse vehicle 10 for capturing data as the refuse vehicle 10 moves along the route 308. In some embodiments, one or more of the sensors 126 and/or devices of the vision system 128 may be located on one or more components of the refuse vehicle 10, such as the engine 18, the transmission 22, the tractive elements 20, the panels 32, the tailgate 34, the lift arms 42, the grabber arms 54, etc. to monitor or otherwise acquire data associated with the performance of the one or more components of the refuse vehicle 10. In some embodiments, one or more sensors 126 and/or devices of the vision system 128 are located within the cab 16 to monitor or otherwise acquire data associated with the performance (e.g., attentiveness, alertness, distractedness, awareness, etc.) of the operator of the refuse vehicle 10.

### Alertness Parameter

In some embodiments, vehicle detection system 430 is configured as an operator alertness system configured to monitor, detect, or otherwise acquire a degree of alertness of the operator of the refuse vehicle 10. Several parameters may be tracked to estimate the degree of alertness of the operator to determine whether the operator is capable of operating the refuse vehicle 10, whether the operator is falling asleep, whether the operator is distracted (e.g., texting, on a phone call, etc.), or any other metric related to the alertness of the operator.

As an operator alertness system, the vehicle detection system 430 may include one or more infrared cameras or body tracking sensors positioned inside the cab 16 to track body movement and positioning of the operator. The vehicle detection system 430 may detect a blink rate, an eye closure duration, a gaze direction, a head tilt, sudden body movements, facial expressions indicating drowsiness or distraction, and/or any other body related data to determine the degree of alertness of the operator. The vehicle detection system 430 may include one or more steering angle sensors or steering torque sensors coupled to the steering system 114 to track sudden, erratic, or irregular steering wheel movements, whether the refuse vehicle 10 is drifting out of the lane in which it is traveling, or any other data related to the steering system 114 to determine the degree of alertness of the operator. In some embodiments, the vehicle detection system 430 provides warnings to be displayed on a graphical user interface generated by the HMI 130 and records a delayed or incorrect response by the operator to the warning. In such an embodiment, the operator alertness system can monitor a cognitive workload of the operator to determine the degree of alertness of the operator. The braking system may include a pressure sensor coupled to the braking system 112 configured to detect sudden, erratic, or irregular brake inputs and the frequency of the brake inputs to determine the degree of alertness of the operator. The operator alert system may utilize any other sensor 126 or device of the vision system 128 to monitor any other parameter (e.g., whether the operator is talking/texting on a phone) to determine the degree of alertness of the operator. The operator alertness system may analyze any one or combination of the parameters as described herein to determine the degree of alertness of the operator.

The operator alertness system may weight or otherwise rank the parameters (e.g., body movement, steering behavior, cognitive workload, braking behavior, or any other parameter) based on relative importance. However, certain parameters may not always be directly correlated with a current condition of the refuse vehicle 10. Therefore, the operator alertness system may implement a dynamic weighting system where the importance of specific parameters is adjusted based on the condition of the refuse vehicle 10. By way of example, when the refuse vehicle 10 is traveling along a route 308 that is winding and includes many turns, the operator alertness system may lower the weight that sudden, erratic, or irregular steering wheel movements have on determining the degree of alertness of the operator. By weighting the parameters according to the condition of the refuse vehicle 10, it is possible to determine the parameter as being closer to an actual degree of alertness of the operator. In some embodiments, the determined degree of alertness of the operator is a value compared to a threshold level of alertness. If the determined degree of alertness of the operator is lower than the threshold level of alertness, it may be determined that the operator is unfit to continue operating the refuse vehicle 10.

In some embodiments, the operator alertness system is configured to monitor the alertness and behavior of the one or more operators performing other vehicle operations. By way of example, the operator alertness system can determine the degree of alertness of the operator while they are standing outside of the cab 16 facilitating refuse collection (e.g., operating the grabber assembly 52), compaction (e.g., operating the compaction system 118), and/or ejection (e.g., operating the packer 46, tailgate 34, etc.) procedures.

### Component Operation Parameter

The vehicle detection system 430 may include one or more sensors 126 and/or devices of the vision system 128 configured to monitor inefficient (e.g., wasted, incorrect, etc.) operations of the lift assembly 40, the lift assembly 50, the grabber assembly 52, and/or any other component of the refuse vehicle 10. In some embodiments, the sensors 126 are configured as load sensors coupled to the lift arms 42, the grabber arms 54, and/or any other component of the lift assembly 40, the lift assembly 50, and/or the grabber assembly 52. In such embodiments, the load sensors record a weight of the refuse can (e.g., refuse container 200) being emptied into the hopper volume for compaction and storage. The vehicle detection system 430 may then make a determination of whether the amount of movement of the lift arms 42 and/or the grabber arms 54 is necessary based on the weight of the refuse can.

In some embodiments, the sensors 126 include proximity sensors configured to detect a distance between (i) the lift arms 42 and/or the grabber arms 54 and (ii) the refuse vehicle 10 to determine whether they are in an incorrect position (e.g., extended for an extended period of time, in a collection position for an extended period of time, etc.) when not in operation (e.g., traveling along the route 308 between stops, parked at a vehicle depot, en route to the landfill 304, etc.). The proximity sensors may be further configured to monitor the number of attempts it takes to grab the target refuse can. In some embodiments, the vision system 128 includes a camera to record video or capture images of the lift arms 42 and/or the grabber arms 54 to determine whether they are in the incorrect position when not in operation.

In some embodiments, the proximity sensors and the vision system 128 facilitate monitoring any unexpected movements of the various components of the refuse vehicle 10 (e.g., the tailgate 34, the lift arms 42, the packer 46, the grabber arms 54, etc.). By way of example, when the refuse vehicle 10 is in transit, the vehicle detection system 430 is configured to detect movement of certain components of the refuse vehicle 10 that are not scheduled (e.g., permitted, usual, expected, etc.). In some embodiments, the vehicle detection system 430 utilizes yet other types of sensors 126, devices, or methods to track the operations of the 1 the various components of the refuse vehicle 10. In some embodiments, the various components of the refuse vehicle 10 are directly communicably coupled with the vehicle detection system 430 and/or the controller 102 to transmit data relating to their operation.

Inefficient, wasted, and incorrect operations of the various components and systems of the refuse vehicle 10 (e.g., the lift assembly 40, the lift assembly 50, the grabber assembly 52, etc.) waste time when the refuse vehicle 10 is at a stop or traveling between stops. Further, the incorrect operations may increase wear on the lift assembly 40, the lift assembly 50, and/or the grabber assembly 52.

### Driving Conditions Parameter

The vehicle detection system 430 may include one or more sensors 126 configured to monitor the driving conditions (e.g., characteristics) of the refuse vehicle 10. The sensors 126 may include an accelerometer, an incline sensor, a gyroscope, a collision detection sensor, and/or other suitable sensors to acquire data regarding an acceleration or G-force that the refuse vehicle 10 is experiencing (e.g., a high speed turn, a collision, etc.), an orientation of the refuse vehicle 10 (e.g., a tip-over condition, tractive elements 20 not contacting the ground surface, etc.), etc. to facilitate monitoring such conditions of the refuse vehicle 10. In some embodiments, the sensors 126 include a tire sensor configured to monitor the conditions and status of the tractive elements 20. By way of example, the tire sensors may acquire data regarding tire pressure, tire wear, tread condition, etc.

### Time-Related Parameter

The vehicle detection system 430 may include one or more sensors 126 or devices configured to monitor operator actions that result in excessive time spent performing certain activities related to refuse collection, transport, and ejection. The vehicle detection system 430 may include the GPS system 124, or components thereof, to monitor the coordinates of the refuse vehicle 10 while performing certain activities related to refuse collection, transport, and ejection. By way of example, the GPS system 124 may operate with an electronic logging device to record the amount of time the refuse vehicle 10 spends at a location (e.g., the time it takes to collect refuse at one stop, the time it takes to empty refuse at the landfill 304), the amount of time it takes for the refuse vehicle 10 to complete the route 308, whether the refuse vehicle 10 deviates from the route 308 (and how long the route deviation takes). The acquired data may include a plurality of entries, with each entry including a sensor data point value (e.g., GPS coordinates) and a timestamp (e.g., from the electronic logging device). By way of another example, an Onboard Diagnostic Device (OBD) may communicably couple the engine 18, the tractive elements 20, and/or the transmission 22 with the vehicle detection system 430 to monitor an idle time of the refuse vehicle 10.

As discussed in greater detail above, the vehicle detection system 430 includes one or more sensors or devices configured to monitor operations of various components of the refuse vehicle 10. By way of example, the vehicle detection system 430 can record the time it takes for the lift assembly 40, the lift assembly 50, and/or the grabber assembly 52 to complete a refuse collection procedure, the time it takes for the refuse vehicle 10 to complete an ejection procedure, and/or any other time it takes for the components of the refuse vehicle 10 to complete a task.

The vehicle detection system 430 may be further configured to detect the number of times the operator of the refuse vehicle 10 exits the cab 16. In some embodiments, a camera is positioned within the cab 16 and/or outside of the cab 16 and configured to record images or videos of each instance that the operator enters/exits the refuse vehicle 10. In other embodiments, a sensor 126 is configured to detect the number of times a driver side cab door opens and closes.

In some embodiments, the vehicle detection system 430 is configured to determine a number of backups (e.g., how many times the refuse vehicle 10 travels backwards) performed by the refuse vehicle 10 during refuse collection, transport, and ejection procedures. The vehicle detection system 430 may be similar to the system as described in greater detail in U.S. application Ser. No. 18/312,256, filed May 4, 2023, the entire disclosure of which is incorporated by reference herein.

### Payload Parameter

The vehicle detection system 430 may include one or more sensors 126 or devices configured to monitor the payload collected and stored in the refuse compartment 30 of the refuse vehicle 10. The sensors 126 or devices may include load cells positioned within the refuse compartment 30 and configured to record a weight of the collected refuse, radio-frequency identification (RFID) sensors configured to scan an RFID tag coupled to the refuse can associated with a type of refuse (e.g., garbage, recycling, hazardous, compost, etc.), cameras configured to monitor a volume of the refuse stored in the refuse compartment 30, cameras configured to detect the type of refuse as it enters the refuse compartment 30, etc. In some embodiments, the sensor 126 is coupled to a tag axle of the refuse vehicle 10. In such an embodiment, the sensor 126 is configured to monitor a position of the tag axle relative to the frame 12 of the refuse vehicle 10, a load placed on the tag axle, or any other information regarding the tag axle. Collectively, the data gathered by the vehicle detection system 430 may be analyzed to determine whether the refuse vehicle 10 is carrying an excessive payload or any other performance metric associated with the payload (e.g., wrong type of refuse, overfilling, inefficient packing procedures, etc.).

### Vehicle Performance Parameter

The vehicle detection system 430 may include one or more sensors 126 configured to monitor operational performance parameters/characteristics of various components of the refuse vehicle 10. By way of example, the sensors 126 may include one or more prime mover sensors (e.g., a speed sensor, an exhaust gas sensor, a NOx sensor, an O2 sensor, etc.) that are configured to facilitate monitoring operational performance parameters/characteristics of the engine 18 (e.g., output speed, output power, output torque, exhaust gas composition, NOₓ levels, O2 levels, etc.). By way of another example, the sensors 126 may additionally or alternatively include one or more transmission sensors that are configured to facilitate monitoring operational performance parameters/characteristics of the transmission 22 (e.g., input speed, output speed, current gear selection, etc.). By way of still another example, the sensors 126 may additionally or alternatively include one or more energy storage sensors (e.g., voltage sensors, current sensors, state-of-charge (SoC) sensors, fuel level sensors, etc.) that are configured to facilitate monitoring operational performance parameters/characteristics of an energy storage (e.g., tank 28, battery system, fuel cell, etc.) of the refuse vehicle 10 (e.g., voltage, current, and/or power of incoming power; voltage, current, and/or power being output to the electrically-operated components of the vehicle 10; a SoC of the energy storage; a health of the energy storage; a fuel level within the tank 28; etc.).

### Start/End of Route Parameter

The vehicle detection system 430 may include one or more sensors 126 or devices configured to monitor whether the operator has completed start and/or end of route procedures. The start and/or end of route procedures may be predetermined and relating to the operations the operator should take before and/or after completing the route 308 and/or any other procedures relating to the operation of the refuse vehicle 10. A start of route procedure may include the operator performing a walkaround to visually or mechanically inspect one or more components of the refuse vehicle 10, “clocking in” to track hours worked, etc. An end of route procedure may include the operator disconnecting any battery systems from a power supply, cleaning one or more components of the refuse vehicle 10, “clocking out” to stop tracking hours worked.

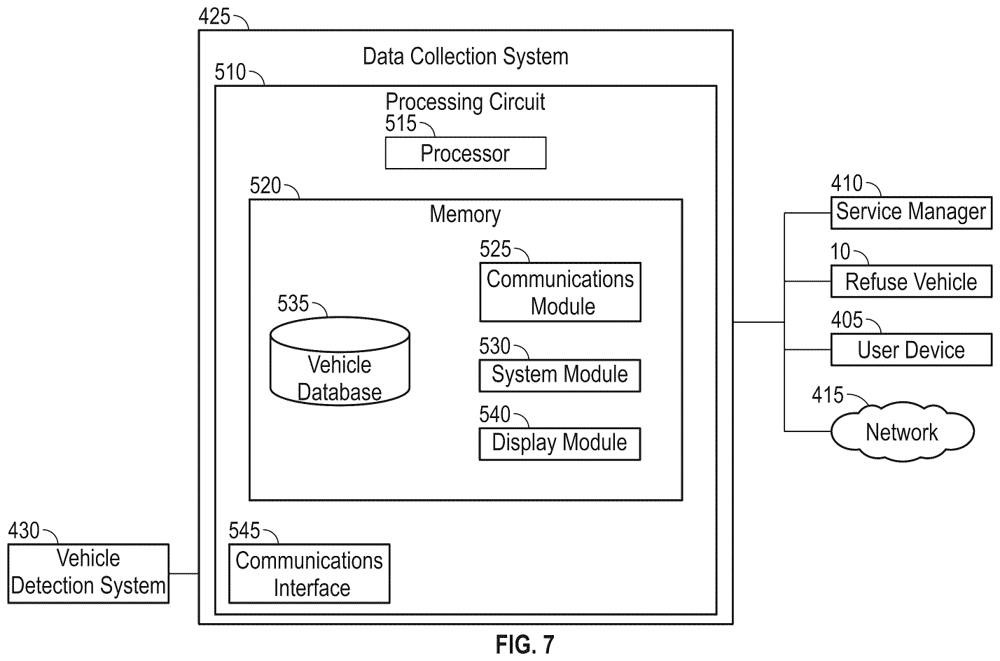

Referring now to FIG. 7, the data collection system 425 includes a processing circuit 510 and a communications interface 545. The processing circuit 510 can include a processor 515 and a memory 520. The memory 520 can include a communications module 525, a system module 530, a vehicle database 535, and a display module 540. The vehicle detection system 430 can interface with the data collection system 425 through the communications interface 545.

The processor 515 may be a general purpose or specific purpose processor, an application specific integrated circuit (ASIC), one or more field programmable gate arrays (FPGAs), a group of processing components, or other suitable processing components. The processor 515 may be configured to execute computer code or instructions stored in the memory 520 or received from other computer readable media (e.g., CDROM, network storage, a remote server, etc.) to perform one or more of the processes described herein. The memory 520 may include one or more data storage devices (e.g., memory units, memory devices, computer-readable storage media, etc.) configured to store data, computer code, executable instructions, or other forms of computer-readable information. The memory 520 may include random access memory (RAM), read-only memory (ROM), hard drive storage, temporary storage, non-volatile memory, flash memory, optical memory, or any other suitable memory for storing software objects and/or computer instructions. The memory 520 may include database components, object code components, script components, or any other type of information structure for supporting the various activities and information structures described in the present disclosure. The memory 520 may be communicably connected to the processor 515 via the processing circuit 510 and may include computer code for executing (e.g., by the processor 515, etc.) one or more of the processes described herein.

The memory 520 is described below as including various modules. While the exemplary embodiment shown in the figures shows each of the modules 525, 530, 535 and 540 as being separate from one another, it should be understood that, in various other embodiments, the memory may include more, less, or altogether different modules. By way of example, the structures and functions of one module may be performed by another module, or the activities of two modules may be combined such that they are performed by only a signal module.

The communications module 525 is configured to facilitate wireless communications with external computing systems (e.g., user devices 405, the service manager 410, the network 415, etc.) and with other refuse vehicles 10 via communications interface 545 (e.g., a transceiver, etc.). The communications interface 545 may support any kind of wireless standard (e.g., 802.11 b/g/n, 802.11a, etc.) and may interface with any type of external computing system including wireless communication capability (e.g., cellular, Wi-Fi, etc.). The communications interface 545 may further facilitate wireless communications with the GPS system 124. The communications module 525 may be any type of capable module (e.g., a CL-T04 CANect® Wi-Fi Module manufactured by HED Inc., etc.) configured to support wireless communications with the external computing systems and other refuse vehicles 10. In one embodiment, the external computing systems communicate with the refuse vehicle 10 via Wi-Fi. In other embodiments, the communications between the external computing systems and/or refuse vehicles 10 is supported via CDMA, GSM, or another cellular connection. In still other embodiments, another wireless protocol is utilized (e.g., Bluetooth, Zigbee, radio, etc.).

The communications module 525 facilitates transmitting the data acquired by the vehicle detection system 430 with respect to the various parameters as described above to the data collection system 425, other refuse vehicles 10, the user device 405, and/or the service manager 410 where the data is analyzed (e.g., weighed, taken into account, considered, etc.) during the determination of the operator score. While the various parameters herein have been described individually, the vehicle detection system 430 and/or any one or more of the controllers of the system 400 (e.g., controller 102) may be configured to monitor for two or more of the parameters simultaneously and choose to transmit or analyze one parameter over the other parameter(s).

The system module 530 is structured to enable the processor 515 of the data collection system 425 to interface with vehicle detection system 430 of the refuse vehicle 10. In the exemplary embodiment shown, the data collection system 425, via the system module 530, may generate an operator score or an operator report based on various sensor data points received from the vehicle detection system 430 (e.g., from the various sensors and devices associated with the various parameters). The operator score or operator report may be generated by comparing the sensor data points received from the vehicle detection system 430. For example, a baseline sensor value for the vehicle detection system 430 may include an initial location of the refuse vehicle 10. Thus, upon receipt of a sensor data point indicative of the location of the refuse vehicle 10, the processor 515 may compare the received data point to the baseline value to determine if a vehicle backup has occurred. The generated report may indicate a total number of vehicle backups. As will be understood, there may be multiple baseline values with respect to each sensor of the vehicle detection system 430.

According to various embodiments, the system module 530 is structured to enable the processor 515 to modify the sample rate of the various sensors included in vehicle detection system 430. By way of example, the processor 515 may modify the sample rate of a particular sensor associated with any one or more parameters in response to detecting a particular operating state. In this sense, the processor 515 may cause each sensor to selectively record data points at predetermined intervals. By way of example, the processor 515 may determine an operating state of the refuse vehicle 10 (e.g., collection procedure, ejection procedure, traveling along the route 308, etc.) and adjust the predetermined intervals accordingly. By way of example, the processor 515 may cause the sample rate of the sensors associated with the component operation parameter to take measurements at a more frequent rate (e.g., compared to a standard/baseline sample rate frequency, compared to the sample rate frequency of sensors associated with other parameters, etc.) when it is determined that the refuse vehicle 10 is completing a refuse collection procedure.

The vehicle detection system 430 may be continuously acquiring data from the sensors associated with the various parameters relating to the performance of the refuse vehicle 10 and the performance of the operator of the refuse vehicle 10 as the refuse vehicle 10 is in operation (e.g., traveling along the route 308, stopped at a stop, traveling to/from the landfill 304, emptying refuse from the refuse compartment 30 at the landfill 304, etc.). In some embodiments, the vehicle detection system 430 captures data surrounding the time period of an event upon a detection of the event. The event may be a detection that the operating condition of the vehicle has exceeded a predetermined threshold of operation. By way of example, an event may include the refuse vehicle 10 traveling over the speed limit along the route 308, the refuse vehicle 10 performing more backups than needed, the refuse vehicle 10 exceeding a predetermined time required to collect refuse from a refuse can at a particular stop, hard braking, or any other irregular, unsanctioned, illegal, or unusual activity performed by the refuse vehicle 10 or the operator (e.g., activities detected by the various sensors associated with the various parameters). Upon a detection of an event, vehicle detection system 430 captures vehicle and operator performance data (e.g., via the various sensors associated with the various parameters) associated with the particular event.

The vehicle detection system 430 may generally receive, process, and transmit the gathered data to the data collection system 425 for further processing. In some embodiments, the data collection system 425 aggregates the data from the various sources (e.g., the various sensors and devices associated with the various parameters, etc.) and generates an operator score or a report including an operator score based on a calculation performed utilizing the data. In some embodiments, the data collection system 425 transmits the data to the service manager 410. In such embodiments, the service manager 410 generates the operator score.

The system module 530 may be structured to interface with various other modules to present the operator score or operator report to an operator and/or other user. By way of example, the system module 530 may interface with the display module 540 to present the operator with the operator score or operator report via the HMI 130. Additionally or alternatively, the system module 530 may interface with the communications module 525 so as to format the operator score or operator report into a webpage or the like that is viewable on a display device (e.g., user device 405) included in an external computing system and transmit the operator score or operator report to the external computing systems (e.g., user devices 405, the service manager 410, the network 415, etc.) and/or with other refuse vehicles 10.

The vehicle database 535 may include, for example, telemetric data captured by the vehicle detection system 430. For example, the system module 530 may include a data logger or the like that stores any sensor data points received from the vehicle detection system 430. The vehicle database 535 may include a plurality of telemetry datasets, with each dataset corresponding to a different sensor device of the vehicle detection system 430. Each dataset may include a plurality of entries, with each entry including a sensor data point value and a time stamp. Additionally or alternatively, the vehicle database 535 may store the operator score or operator report generated via the system module 530.

The stored data may be removed from the vehicle database 535 once the data is uploaded to a remote cloud storage. By way of example, long-term storage of the telemetry data and other data may be done on a centralized server, and communications interface 545 may wirelessly connect with a remote server to transmit and store the data. The data includes a time stamp, vehicle identifier, and operator identifier information to identify the data in remote server. In some embodiments, the service manager 410 can perform similarly functionality to a remote server.

In one embodiment, the data is automatically updated periodically. The data may also be updated upon user request. A controller area network (CAN) controller, such as system module 530 or another module may be configured to monitor the data and to determine when a operational status of the refuse vehicle 10 has changed based on the telemetry data changes (e.g., determine that the refuse vehicle 10 is performing a collection procedure, a compaction procedure, etc.).

According to various embodiments, the processor 515 may selectively transmit a subset of the data (e.g., data points from a specific subset of sensors associated with a specific parameter) in response to an operating state of the refuse vehicle 10 being determined. By way of example, the data collection system 425 may transmit data points from certain sensors (e.g., proximity sensors coupled to the lift arms 42) at a higher rate during a refuse collection procedure than other sensors (e.g., an engine output sensor). By reducing the total number of data points being transmitted, the strain on the communications interface 545 may be reduced.

Vehicle database 535 may be any type of database (e.g., a SQLite database, etc.), and modules 525, 530, 540 may query the database using any type of language or method via backend framework. The backend framework of data collection system 425 may support the activities of periodically updating and querying vehicle database 535, as well as providing web layer authentication (e.g., to authenticate devices that attempt to access data from vehicle database 535, etc.). The backend framework may further support the various security-related functionality of communications module 525.

Data collection system 425 may include, for example, a data transport protocol layer configured to facilitate the query of data from vehicle database 535 for use by the various modules of memory 520. In one embodiment, at least one of web sockets and AJAX polling is used to invoke queries via backend framework and provide the data to the frontend applications (e.g., the application layer, the modules, etc.), as they allow changes to the vehicle database 535 to be detected and pushed to the application layer. The use of web sockets and/or AJAX may be based on compatibility constraints and performance constraints with the external computing system accessing the data collection system 425. The application layer, or the frontend application, of data collection system 425 may be built using, for example, HTML5, CSS, and various Javascript libraries.

In some embodiments, the service manager 410 can perform similar functionality to the data collection system 425 and/or the vehicle detection system 430. By way of example, the data collected by the vehicle detection system 430 can be provided to the service manager 410. The service manager 410 can use the data to generate an operator score or operator report.

### Operator Score Calculation

The system module 530 is configured to analyze the data received from the vehicle detection system 430 to calculate an operator score associated with a particular operator of the refuse vehicle 10. Similarly, the system module 530 is configured to generate an operator report including the data with respect to each parameter that, collectively, provide an indication of the performance of the operator. In some embodiments, the system module 530 utilizes data based on parameters other than the ones disclosed herein that generally relate to the performance of the operator of the refuse vehicle 10 to generate the operator score and the report. In some embodiments, the vehicle detection system 430 transmits the parameter data to the external computing systems (e.g., user devices 405, the service manager 410, the network 415, etc.) and/or with other refuse vehicles 10 to (i) generate the operator score and/or operator report, (ii) display the operator score and/or operator report, and/or (iii) otherwise manipulate the parameter data.

The system module 530 may employ one or more models (e.g., methods, algorithms, systems, calculations, etc.) to aggregate the various parameter data and calculate an operator score and generate an operator report. In some embodiments, it may be advantageous to normalize the data across all of the parameters to a common unit. Normalizing the data may involve converting the gathered data into a percentage or common score such that data having of a first type (e.g., unit of measurement, signal type, scale, etc.) can be directly compared against data having a second type (e.g., such that a time measurement can be compared against a degree of alertness).

According to an exemplary embodiment, the system module 530 normalizes the parameter data by comparing the gathered data to a baseline level then standardizing the parameter data as a standardized (e.g., common) data type. To establish a baseline level of data, the system module 530 may aggregate parameter data gathered by the vehicle detection system 430 over the course of predetermined number of routes 308 completed (e.g., 100 or more routes completed, 500 or more routes completed, etc.) or hours of operation of the refuse vehicle 10 (e.g., 100 hours, 500 hours, etc.). Each parameter dataset gathered by the vehicle detection system 430 to generate the baseline level of data may correspond to (i) a different parameter monitored by the vehicle detection system 430 and (ii) a different sensor device of the vehicle detection system 430. Each parameter dataset may include a plurality of entries, with each entry including a sensor data point value. The system module 530 may determine a minimum data point value, a maximum data point value, an average data point value, or any other metric of the data point values for each parameter data set.

After establishing a baseline level of data for each parameter dataset, the system module 530 may scale (e.g., minimum-maximum scaling, z-score normalization, interquartile range scaling, unit vector transformation, etc.) each dataset associated with a different parameter (e.g., the data gathered by the vehicle detection system 430), and having a different type (e.g., GPS coordinates, weight data, time logs, video recordings, etc.). Once the parameter datasets are of a common type, the system module 530 may compare each parameter dataset equally against one another and aggregate the data to calculate the operator score. Normalizing the data ensures that the different types of data (e.g., GPS coordinates, weight data, time logs, video recordings, etc.) can be directly compared and contribute equally to the analytical processes performed by the system module 530 to generate the operator score.

In some embodiments, the normalized data for a particular parameter is compared to a predetermined threshold level of that particular parameter. In some embodiments, if the normalized data for a particular parameter is lower (or higher) than the threshold level for that particular parameter, the operator score may be adjusted accordingly to reflect crossing the threshold. By way of example, the system module 530 may recognize a certain number of backups that are required along a route 308. If the vehicle detection system 430 detects that the refuse vehicle 10 performed a number of backups that exceeds the threshold level of backups, the operator score may be decreased. If the normalized data associated with a particular operator is lower (or higher) than an overall threshold level, it may be determined that the operator is unfit to continue operating the refuse vehicle 10. In some embodiments, if the normalized data for a particular parameter is lower (or higher) than an average level for the particular parameter, the operator score may be adjusted accordingly to reflect the deviation from the average level. By way of example, the system module 530 may calculate an average time it should take for a refuse vehicle 10 to complete a route 308 (e.g., based on the baseline data). If the vehicle detection system 430 detects that the refuse vehicle 10 completed the route 308 in a time that is faster than the average time, the operator score may be increased.

For certain parameter datasets that are not associated with a quantifiable number (e.g., video recordings or images associated with phone use, etc.), the system module 530 may analyze the gathered data (e.g., using machine learning trained on the baseline data) to extract relevant features, patterns (e.g., phone use while operating the refuse vehicle 10), objects (e.g., a phone) in the data to convert the video/image data into a numerical representation that can be used in the analytical processes performed by the system module 530 to generate the operator score.

In some embodiments, the system module 530 employs a rule based model to calculate the operator score. By way of example, the system module 530 may analyze the parameter datasets according to rules configured by a user (e.g., an employer, an operator, a customer, etc.) and calculate or otherwise adjust the operator score upon a detection of the rule being triggered. The rules may be predetermined. By way of example, a rule may include a timing rule wherein if the operator exceeds the time defined by the rule to perform a certain task (e.g., time to complete the route 308, time to collect refuse at a stop, time of engine 18 idling between stops, etc.), the operator score is decreased. By way of another example, a rule could be a location rule wherein if the operator drives the refuse vehicle 10 outside a defined boundary (e.g., the neighborhood 302), does not follow a particular route 308, etc., the operator score is decreased.

The system module 530 may employ a method that weighs or otherwise ranks the parameters (e.g., alertness, component operation, time-related, payload, vehicle performance, start/end of route, or any other parameter) based on relative importance. The employer (e.g., supervisor) may place certain emphasis on certain parameters based how important of a role they believe the parameter plays in the analysis and calculation of the operator score. By way of example, saving money may be the most important factor for the employer. Therefore, the time-related parameters may be weighted with the most importance when calculating the operator score. Parameters such as payload and start/end of route parameters may be the least important parameters and may be weighted less severely (e.g., not taken as much into consideration) than the time-related parameters when performing the calculations to determine the operator score. In some embodiments, weights of the various parameters can be determined through consultation with safety experts, regulatory compliance standards, or based on the employer's priorities. Generally, employing a method that weighs parameters ensures that critical aspects of the operation of the refuse vehicle 10 by the operator have a more significant impact on the operator score.

In some embodiments, certain parameters may not be directly correlated with or relevant to a current condition/state of the refuse vehicle 10. Therefore, the system module 530 may implement a dynamic weighting system where the importance of specific parameters is adjusted based on the condition/state of the refuse vehicle 10. By way of example, when the refuse vehicle 10 is traveling along a route 308 that is winding and includes many turns, the system module 530 may lower the weight that sudden, erratic, or irregular steering wheel movements have on determining the operator score. By way of another example, if the refuse vehicle is collecting refuse along a route 308 in an urban setting (e.g., New York City, Los Angeles, etc.), the system module 530 may lower the weight that excessive stops and excessive backups have on determining the operator score. By weighting the various parameters according to the condition of the refuse vehicle 10, it is possible to determine the value the various data associated with any specific parameter has on an actual measure of the performance of the operator.

Generally, the operator score and/or operator report help provide the operator, the employer of the operator, and/or a customer subscribing to a service of the employer insight into the performance of the operator. The operator score and/or operator report may provide the operator feedback relating to specific parameters/categories of operation at which they could improve. By way of example, the operator report may indicate that the operator should be trained on the proper and most efficient methods of engaging a refuse can to collect refuse. The operator score and/or operator report may provide the employer of the operator valuable insight into how to mitigate risk associated with one or more operators, areas of operation where one or more operators could improve efficiency, areas of operation that pose safety risks to the operator, which operators are the most/least efficient, etc. A supervisor of the operator may otherwise review the operator report and/or the operator score to understand the performance of the operator. The operator score and/or report may be provided to customers to provide insight into the efficiency of the operator and the environmental consciousness of the employer.

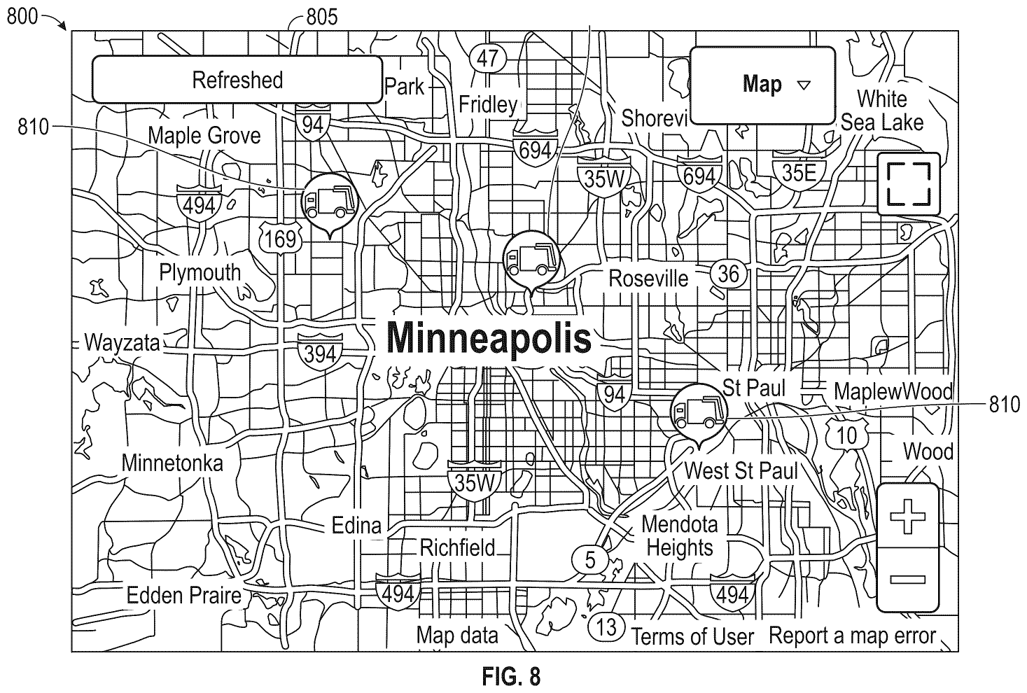

Referring now to FIG. 8, a user interface 800 is displayed. The user interface 800 includes a map 805. The map 805 can include a visual representation of a vehicle (e.g., a visual representation of the refuse vehicle 10). In some embodiments, the visual representation is a vehicle icon 810. In some embodiments, the location of the vehicle icon 810, as shown in the user interface 800, can be associated with a location where an event was detected. In some embodiments, the map 805 displays the actual route taken by a vehicle compared to the most optimized route the vehicle should have taken. In some embodiments, the data collection system 425 can generate the information displayed in FIG. 8. In some embodiments, the user interface 800 can be provided to a display device (e.g., HMI 130 or user device 405).

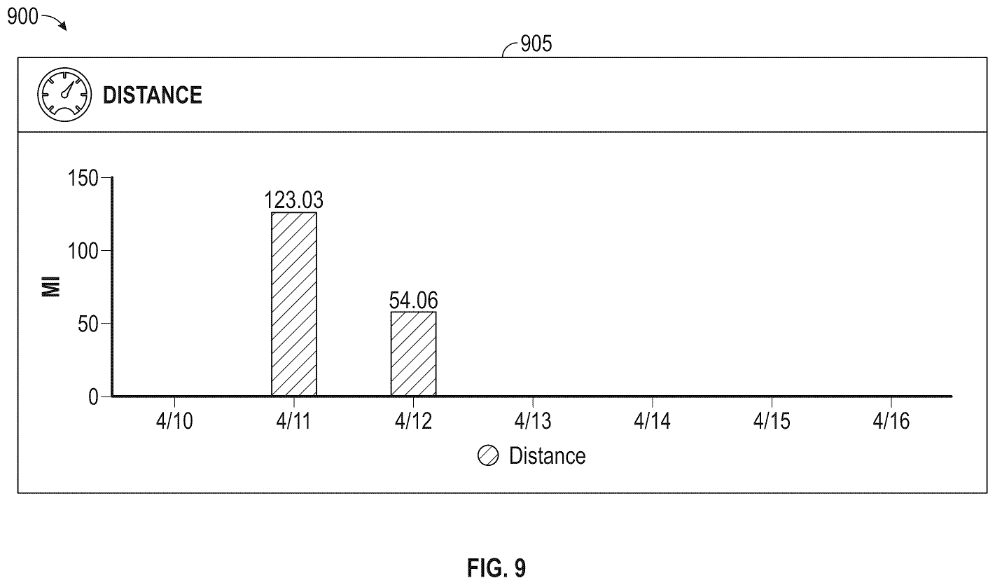

Referring now to FIG. 9, a user interface 900 is displayed. The user interface 900 includes a graphical representation 905 of vehicle information. By way of example, the vehicle information may include a distance traveled by a vehicle. In some embodiments, the data collection system 425 generates the information displayed in FIG. 9. In some embodiments, the user interface 900 is provided to a display device (e.g., HMI 130 or user device 405). In some embodiments, the information displayed in FIG. 9 is included in the operator report. In some embodiments, the user interface 800 and the user interface 900 are included within a single user interface (e.g., the user interfaces are combined).

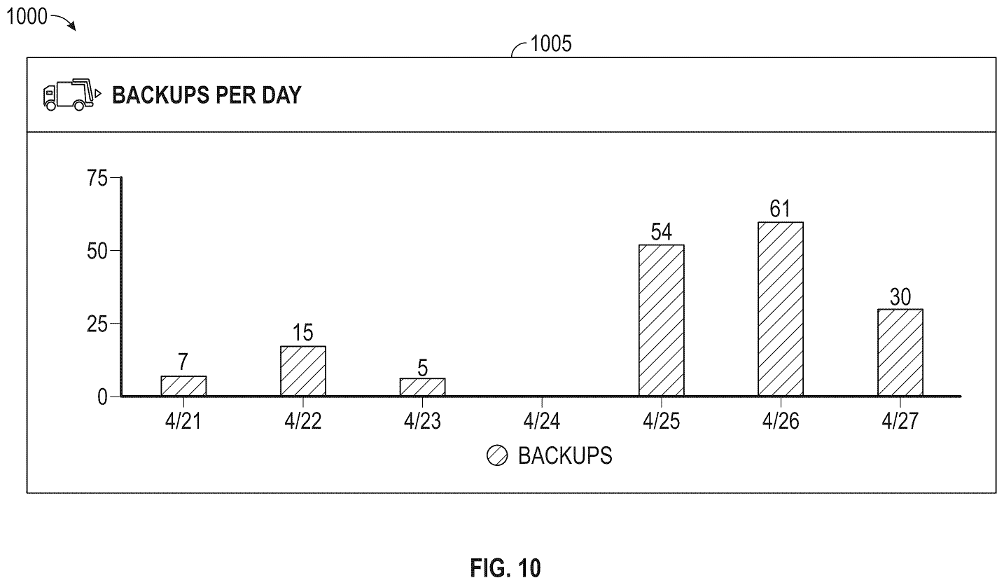

Referring now to FIG. 10, a user interface 1000 is displayed. The user interface 1000 includes a graphical representation 1005 of vehicle information. By way of example, the vehicle information may include an amount of vehicle backups performed by a vehicle. In some embodiments, the data collection system 425 generates the information displayed in FIG. 10. In some embodiments, the user interface 1000 is provided to a display device (e.g., HMI 130 or user device 405). In some embodiments, the information displayed in FIG. 10 is included in the operator report. In some embodiments, the user interface 800, the user interface 900, and the user interface 1000 are included within a single user interface (e.g., the user interfaces are combined).

Referring now to FIG. 11, a user interface 1100 is displayed. The user interface 1100 includes information associated with a vehicle. By way of example, the information may include a total fuel icon 1105, an idle fuel icon 1110, an idle time icon 1115, an engine time icon 1120, a miles icon 1125, an arm dumps icon 1130, an eject cycles icon 1135, a packer cycles icon 1140, a payload weight icon 1145, and a tire pressure icon 1150. In some embodiments, the user interface 1100 displays more information relating to data gathered by the vehicle detection system 430. In some embodiments, the data collection system 425 generates the information displayed in FIG. 11. In some embodiments, the user interface 1100 is provided to a display device (e.g., HMI 130 or user device 405). In some embodiments, the information displayed in FIG. 11 is included in the operator report. In some embodiments, the user interface 800, the user interface 900, the user interface 1000, and the user interface 1100 are included within a single user interface (e.g., the user interfaces are combined).

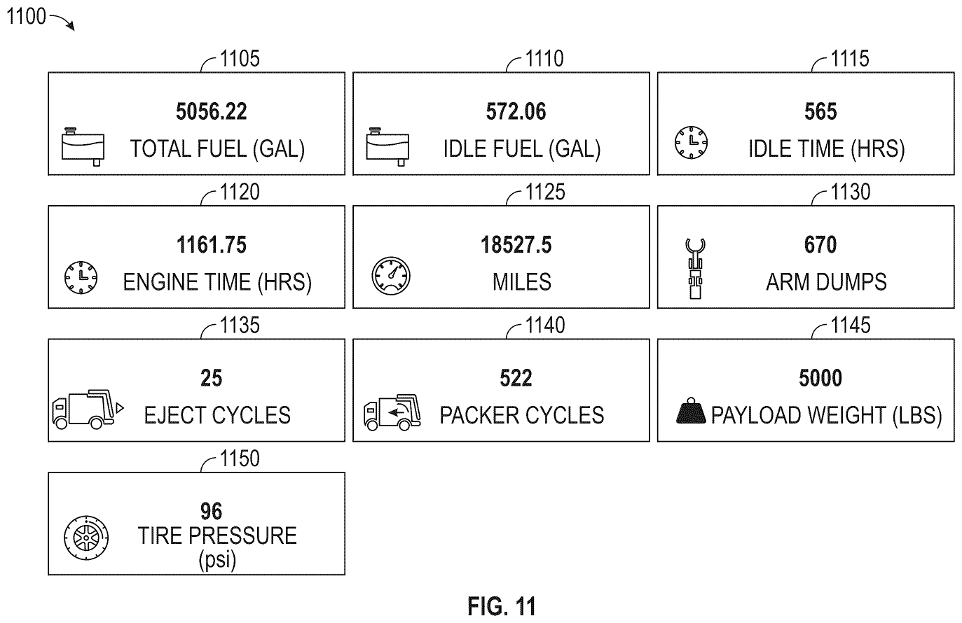

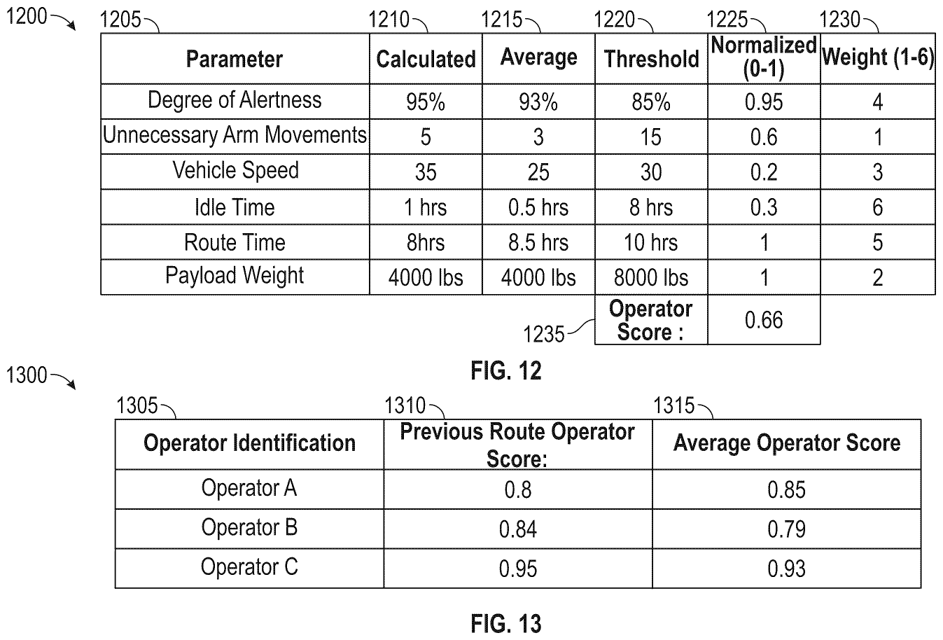

Referring now to FIG. 12, a user interface 1200 is displayed. The user interface 1200 includes operator performance information illustrated in an operator report. The operator performance information includes data gathered from the various sensors and devices of the vehicle detection system 430. The user interface 1200 includes a parameter icon 1205, a calculated icon 1210, an average icon 1215, a threshold icon 1220, a normalized icon 1225, a weight icon 1230, and an operator score icon 1235. The icons may illustrate an association between information. By way of example, the parameter icon 1205 may illustrate the parameter associated with the data collected by the vehicle detection system 430, the calculated icon 1210 may illustrate a value of the data collected by the vehicle detection system 430 (e.g., at a point in time while traveling along the route 308, upon a detection of an event, etc.), the average icon 1215 may illustrate the average value of the data collected (e.g., average from one route 308, average from one week worth of routes, lifetime average data, etc.), the threshold icon 1220 may illustrate a threshold value, the normalized icon 1225 may illustrate the collected data normalized on a common scale from 0 to 1, the weight icon 1230 may illustrate the weight associated with the parameter, and the operator score icon 1235 may illustrate a total calculated operator score for a particular operator. In some embodiments, the user interface 1200 includes operator performance information for more than one operator. In some embodiments, the user interface 1200 displays more information relating to data gathered by the vehicle detection system 430. In some embodiments, the data collection system 425 generates the information displayed in FIG. 12. In some embodiments, the user interface 1200 is provided to a display device (e.g., HMI 130 or user device 405). In some embodiments, the information displayed in FIG. 12 is included in the operator report. In some embodiments, the user interface 800, the user interface 900, the user interface 1000, the user interface 1100, and the user interface 1200 are included within a single user interface (e.g., the user interfaces are combined).

Referring now to FIG. 13, a user interface 1300 is displayed. The user interface 1300 includes operator scores of multiple operators illustrated in an operator report. The operator performance information includes operator score information generated by the system module 530. The user interface 1300 includes an operator identification icon 1305, a previous route operator score icon 1310, and an average operator score icon 1315. The icons may illustrate an association between information. By way of example, the operator identification icon 1305 may illustrate the identification (e.g., name, employee ID, etc.) of the operator, the previous route operator score icon 1310 may illustrate a value of the operator score calculated by the system module 530 for the previous route 308 that the operator completed, and the average operator score icon 1315 may illustrate the average value of the calculated operator scores (e.g., average from one week worth of routes 308, lifetime average data, average score on a particular day of the week, etc.). In some embodiments, the user interface 1300 displays more information relating to data gathered by the vehicle detection system 430 or generated by the system module 530. By way of example, a user may interact with the user interface 1300 (e.g., via touchscreen, buttons, etc.) to expand the rows for each operator to display more information, such as the information displayed by user interface 1200. In some embodiments, the data collection system 425 generates the information displayed in FIG. 13. In some embodiments, the user interface 1300 is provided to a display device (e.g., HMI 130 or user device 405). In some embodiments, the information displayed in FIG. 13 is included in the operator report. In some embodiments, the user interface 800, the user interface 900, the user interface 1000, the user interface 1100, the user interface 1200, and the user interface 1300 are included within a single user interface (e.g., the user interfaces are combined).

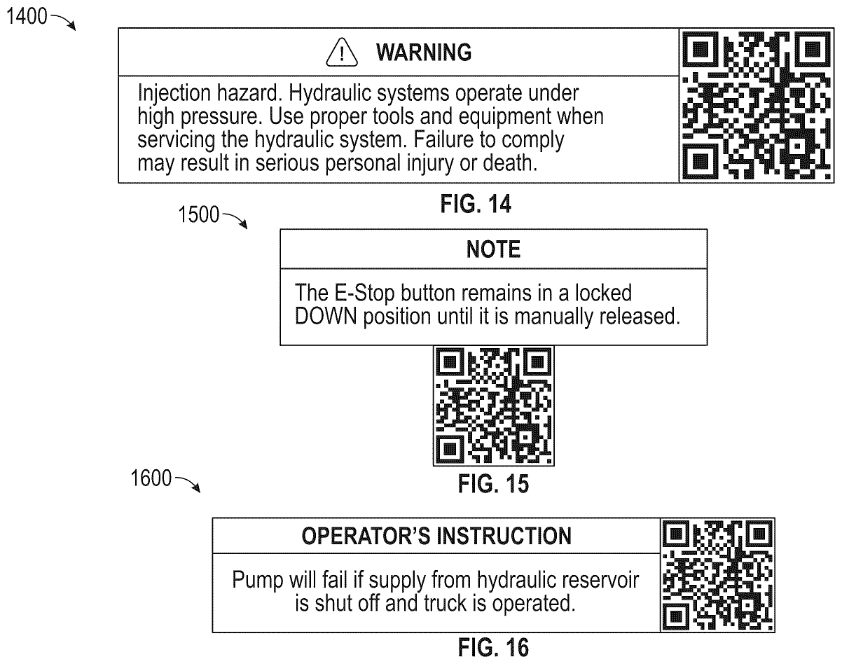

Referring now to FIGS. 14-16, tags, shown as tag 1400, tag 1500, and tag 1600, may be physical tags or a descriptive label that is applied (e.g., affixed, coupled, connected, adhered, etc.) to any type of equipment or component of the refuse vehicle 10. In some embodiments, the information included in the tags is provided to a display device such as the user interfaces described above, the HMI 130, and/or the user device 405. A device (e.g., the user device 405, a mobile phone, a tablet, etc.), the device is configured to receive and interpret data from (e.g., read) the tags. Reading the tags may include a method of deciphering what the tags correspond to. By way of example, the tag 1400 may correspond to displaying the information included in any one or more of the user interfaces described above. By way of another example, the tag 1500 may be located on a surface of the grabber arms 54 and correspond to material about how to operate the grabber assembly 52, including videos, how-to guides, manuals, etc. The tags 1400, 1500, 1600 may be similar to the tags as described in greater detail in U.S. Pat. No. 11,727,230, filed Jan. 28, 2022, the entire disclosure of which is incorporated by reference herein.

The information deciphered (e.g., tag data) may be associated with the parameter data gathered by the vehicle detection system 430, the operator score and/or operator report generated by the system module 530, and/or any information associated with user interfaces 800, 900, 1000, 1100, 1200, or 1300. The tags 1400, 1500, and 1600 include an identifier such as a QR code or another machine-readable optical label such as a one dimensional barcode (e.g., UPC) or two dimensional matrix barcode (e.g., DataMatrix, Grid Matrix, etc.). In other embodiments, the identifier is a machine sensible label such as an RFID tag, rather than machine-readable optical label.

The arrangements and designs of the tag 1400 (FIG. 14), tag 1500 (FIG. 15), and tag 1600 (FIG. 16) are shown for illustrative purposes only. It will be appreciated that many alternatives and combinations are possible without departing from the inventive concepts disclosed herein. By way of example, the position of the identifier relative to the text may be different in various exemplary embodiments. Additionally, in some embodiments, the tag only includes the identifier without the text. In other embodiments, the tags include multiple identifiers of the same and/or different type.

The tag data includes material that may be presented to an employer of the operator and/or the operator. The material may include the operator score and/or the operator report including gathered data from the vehicle detection system 430. The material may be presented to improve operator safety and/or facilitate training regarding equipment operation. By way of example, the system module 530 and/or the employer may determine, based on (i) the parameter data, (ii) an analysis performed by the system module 530, and/or (iii) the operator score, which parameters and/or procedures the operator can improve upon. By way of example, the system module 530 may determine that, based on a poor operator score, the operator needs training on how to properly collect refuse at a stop without spending excessive time idling. In response to such a determination, a user interface (e.g., HMI 130, user device 405) may provide a tag (e.g., tag 1400, tag 1500, tag 1600, etc.) corresponding to materials relating to proper refuse collection procedures. The material presented may be a single format of material (e.g., only videos) or multiple formats of material (e.g., videos, manuals, recordings, diagrams, etc., and combinations thereof).

In some embodiments, the system module 530, based on the parameter data collected gathered by the vehicle detection system 430, may determine that various components of the refuse vehicle 10 need to be serviced, checked, and/or replaced. In such embodiments, a user interface (e.g., HMI 130, user device 405) provides a tag (e.g., tag 1400, tag 1500, tag 1600, etc.) corresponding to materials relating to service guides (e.g., videos, audio files, augmented reality walkthroughs, manuals, etc.), parts information (e.g., part numbers, a URL/website to a replacement part, etc.), patent information (e.g., specification, figures, patent number, application number, publication number, etc.).

According to an exemplary embodiment, the material is provided to the user device 405. The material is provided to the user device 405 via an internet browser installed on the user device 405 or via an application generated and/or transmitted from the controller 102 to the user device 405. Providing the material may include generating the application and/or transmitting the application from the controller 102 to the user device 405 via network 415.

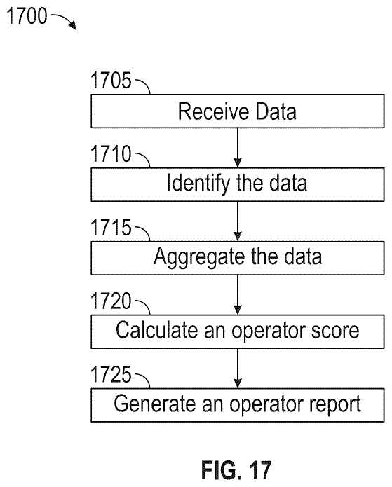

Referring now to FIG. 17, a process 1700 is shown. In some embodiments, the data collection system 425, the vehicle detection system 430, and/or the service manager 410 performs the process 1700. The process 1700 may be implemented for calculating an operator score and generating an operator report based on collected data.

At step 1705, data is received from one or more sensors (e.g., sensors 126), devices (e.g., a camera of the vision system 128), and/or systems (e.g., vehicle detection system 430). The data may be associated with one or more vehicle performance and/or operator performance metrics. The data may include location data, weight data, velocity data, operator alertness data, time logs, and/or any other data related to the functionality and/or performance of the vehicle (e.g., refuse vehicle 10) or operator.

At step 1710, the data is identified or otherwise filtered. A system module (e.g., system module 530) may identify the received data and identify which parameter the data is associated with. By way of example, the system module may identify engine idle time data with a time-related parameter. By way of another example, the system module may identify acceleration or G-force data with a driving conditions parameter.

At step 1715, the system module implements a model to aggregate the data. By way of example, the system module may normalize the data such that data having different types (e.g., units, file formats, etc.) can be directly compared against one another. The model may include a standardization model, a rule-based model, a threshold-based model, a weighted analysis model, or any other method, system, algorithm to aggregate the data. In some embodiments, the system module compares the data to baseline the data, the baseline data pertaining to a baseline value of the operations of the vehicle.

At step 1720, an operator score is calculated. The system module may analyze the aggregated data and calculate the operator score that provides an indication regarding the performance (e.g., efficiency, safety, etc.) of the operator.

At step 1725, a report is generated. The report may include the calculated operator score, the received and aggregated data, and/or any other data related to the operator (e.g., name, employee ID, vehicle ID, etc.). The report may include information related to two or more operators. In some embodiments, the report may be provided to a user. The report may be displayed using a user interface. By way of example, a communications module (e.g., communications module 525) may interface with a user device (e.g., user device 405). The communications module may provide the report to the user device and the user device may display the report using a user interface associated with the user device. A user associated with the user device can view the information associated with the report. By way of example, the user may view the operator scores associated with one or more operators. In some embodiments, the user provides an indication to a data collection system (e.g., data collection system 425). The indication may be an indication to recommend training associated with a particular parameter for a particular operator. By way of example, the system module may identify the report associated with the indication. The system module may associate a tag (e.g., tag 1400, tag 1500, tag 1600) with the report and provide the tag to the user to be scanned. The tag may provide information associated with training materials for a specific component of the vehicle based on the indication.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for monitoring an operation of a refuse vehicle, the system comprising:
a device configured to collect data pertaining to operations of the refuse vehicle and a performance of an operator; and
one or more processing circuits in communication with the device, the one or more processing circuits configured to:
receive, from the device, the data pertaining to operations of the refuse vehicle and the performance of the operator;
analyze the data based on baseline data, the baseline data pertaining to a baseline value of the operations of the refuse vehicle and the performance of the operator;
generate, based on an analysis of the data, an operator score; and
provide, via a display, a user interface that includes the operator score.

2. The system of claim 1, wherein the data pertaining to operations of the refuse vehicle and the performance of the operator is associated with a performance parameter including at least one of an alertness parameter, a component operation parameter, a driving condition parameter, a time parameter, a payload parameter, a route parameter, or a refuse vehicle performance parameter.

3. The system of claim 2, wherein the performance parameter includes the alertness parameter, and wherein the one or more processing circuits are configured to analyze data associated with body movement and positioning of the operator to determine a degree of alertness of the operator and generate the operator score based on the degree of alertness.

4. The system of claim 2, wherein the performance parameter includes the component operation parameter, and wherein the one or more processing circuits are configured to analyze data associated with operation of at least one of a lift assembly or a grabber assembly of the refuse vehicle to generate the operator score.

5. The system of claim 2, wherein the performance parameter includes the driving condition parameter, and wherein the one or more processing circuits are configured to analyze data associated with at least one of an acceleration or an collision of the refuse vehicle to generate the operator score.

6. The system of claim 2, wherein the performance parameter includes the time parameter, and wherein the one or more processing circuits are configured to analyze data associated with a time it takes the refuse vehicle to complete a task to generate the operator score.

7. The system of claim 2, wherein the performance parameter includes the payload parameter, and wherein the one or more processing circuits are configured to analyze data associated with at least one of a weight or a volume of refuse received in a refuse compartment of the refuse vehicle to generate the operator score.

8. The system of claim 2, wherein the performance parameter includes the route parameter, and wherein the one or more processing circuits are configured to analyze data associated with a route procedure performed by the operator to generate the operator score.

9. The system of claim 2, wherein the performance parameter includes the refuse vehicle performance parameter, and wherein the one or more processing circuits are configured to analyze data associated with operation of at least one of a prime mover or an energy storage device of the refuse vehicle to generate the operator score.

10. The system of claim 2, wherein the data pertaining to operations of the refuse vehicle and the performance of the operator associated with a first performance parameter of a first type is different than a second type of a second performance parameter.

11. The system of claim 10, wherein the one or more processing circuits are configured to:
aggregate the data collected by the device;
normalize the data associated the first performance parameter and the data associated with the second performance parameter to have a common type; and
generate the operator score based on the normalized data.

12. The system of claim 2, wherein the one or more processing circuits are configured to generate the operator score based on a weight associated with the performance parameter.

13. The system of claim 1, wherein the device configured to collect data pertaining to operations of the refuse vehicle and the performance of the operator includes at least one sensor coupled to the refuse vehicle.

14. The system of claim 13, wherein the at least one sensor includes at least one of a visible light camera, a LIDAR camera, or a radar sensor.

15. The system of claim 1, wherein the one or more processing circuits are configured to provide, responsive to an input from the operator, via the display, the user interface that includes information relating to an operation of the refuse vehicle.

16. The system of claim 1, wherein the one or more processing circuits includes at least one of (i) a first processing circuit located on the refuse vehicle or (ii) a second processing circuit located remote from the refuse vehicle.

17. An operator feedback system for a refuse vehicle, the operator feedback system comprising:
one or more processing circuits comprising one or more memory devices coupled to one or more processors, the one or more memory devices configured to store instructions thereon that, when executed by the one or more processors, cause the one or more processors to:
receive, from one or more sensors, data associated with a performance parameter regarding an operation of the refuse vehicle and a performance of an operator;
analyze the data based on baseline data, the baseline data including a baseline value of the performance parameter;
generate, based on an analysis of the data, an operator score indicative of the operation of the refuse vehicle and the performance of the operator;
provide, via a display, a user interface that includes the operator score; and
provide, via the display, feedback to the operator regarding the operation of the refuse vehicle and the performance of the operator to improve the operator score, wherein the performance parameter includes at least one of an alertness parameter, a component operation parameter, a driving condition parameter, a time parameter, a payload parameter, a route parameter, or a refuse vehicle performance parameter.

18. The operator feedback system of claim 17, wherein the performance parameter a first performance parameter of a first type and a second performance parameter of a second type different than the first type.

19. The operator feedback system of claim 18, wherein the instructions cause the one or more processors to:
aggregate the data received from the one or more sensors;
normalize the data associated the first performance parameter and the data associated with the second performance parameter to have a common type; and
generate the operator score based on the normalized data.

20. A method for monitoring an operation of a refuse vehicle, the method comprising:
receiving, from one or more sensors, data associated with a first performance parameter and a second performance parameter regarding an operation of the refuse vehicle and a performance of an operator;
aggregating the data received from the one or more sensors;
normalizing the data associated the first performance parameter and the second performance parameter to have a common type;
generating, based on the normalized data, an operator score indicative of the operation of the refuse vehicle and the performance of the operator;
providing, via a display, a user interface that includes the operator score; and
providing, via the display, feedback to the operator regarding the operation of the refuse vehicle and the performance of the operator to improve the operator score.
